(19) United States
(12) Patent Application Publication
(10) Pub. No.: US 2006/0051490 A1
(43) Pub. Date: Mar. 9, 2006

(54) Food component and processes for the preparation thereof

(76) Inventor: Avraham Baniel, Jerusalem (IL)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/537,086

(22) PCT Filed: Jan. 8, 2004
(86) PCT No.: PCT/IL04/00014

§ 371 Date: Jun. 1, 2005

(30) Foreign Application Priority Data
Jan. 16, 2003 (IL) 153994
Dec. 31, 2003 (IL) 159666

(51) Int. Cl. A23L 1/221

(52) U.S. Cl. 426/650

(57) ABSTRACT

The invention provides a process for the preparation of food acidulants comprising esterifying a fatty acid glyceride esterified by at least one fatty acid selected from the group consisting of fatty acids found in edible oils and fats with at least one carboxylic acid selected from the group of acidulant acids consisting of acetic acid, lactic acid, fumaric acid, malic acid, tartaric acid and citric acid to produce an oil soluble, acidulant, food component.

The present invention relates to a food component and to a process for the preparation of food acidulants.

More particularly, the present invention provides novel, oil-soluble food ingredient compositions for human consumption. These compositions consist of oils and fats combined with specific carboxylic acids. The oils and fats in the present invention are vegetable oils and animal fats that are commonly used in food as well as mixtures of these oils and fats and include chemically modified oil and fat derivatives (such as hydrogenated oils) that are in common use in food preparation. All of these will be referred to collectively hereinafter as “oils”. The carboxylic acids that are intended for use in the present invention are limited to and comprise specifically:

| Name of acid | Formulae, detailed and global | | MW |
|---|---|---|---|
| Acetic | CH₃COOH | C₂H₄O₂ | 60 |
| Lactic | CH₃CH₂(OH)COOH | C₃H₇O₃ | 91 |
| Fumaric | HOOC—CH═CH—COOH | C₄H₄O₄ | 116 |
| Malic | HOOC—CH₂CH(OH)—COOH | C₄H₆O₅ | 134 |
| Tartaric | HOOC—CH(OH)—CH(OH)—COOH | C₄H₆O₆ | 150 |
| Citric | HOOC—CH₂—(HO)C(COOH)—CH₂—COOH | C₆H₈O₇ | 192 |

These acids are common food ingredients and practically represent the only water soluble carboxylic acids present in non-adulterated foods. They are natural flavors and acidulants, each acid providing a characteristic flavor. Those that are of C₄ and higher possess also pronounced anti-oxidant properties. In the text that follows they are referred to collectively as acidulant acids.

Acetic acid and lactic acid are miscible with water in all proportions. The solubilities of fumaric, malic, tartaric and citric in 100 parts of water at room temperature approximate respectively to: 1.5; 150; 140; 133 parts. The pronounced hydrophilic character due to the carboxylate and hydroxyl groups that constitute a large part of the molecules of all the acidulant acids is paralleled by their oleophobic characteristics. In fact, their solubility in oils, especially in the presence of an aqueous phase, is practically nil. Acid flavors in food are thus virtually conveyed solely through the aqueous phase that a food contains. Conveying acidic flavors in foods that contain non-aqueous constituents is in fact an important aspect of the art and science of food preparation.

The present invention provides completely novel acidic flavors, as well as precursors of such novel acidic flavors, that are freely soluble in oils. They consist of glyceride ester compositions obtained by esterifying a glyceride composition by one of the carboxylic acids listed above. The term “glyceride composition” in the present context designates mono-glycerides, di-glycerides and mixture thereof consisting of fatty acid esters of glycerol wherein all the fatty acids originate in oils as defined above that are accepted for human consumption and are chemically unchanged by being processed into forming the glyceride composition that contains them. The fatty acids comprise saturated straight chain acids in C₆ to C₁₈ that are constituents of coconut oil and fats of animal origin as well as unsaturated straight chain acids e.g. oleic acids that are constituents of vegetable oils—in short fatty acids derived, from oils and fats accepted for human nutrition.

A glyceride ester composition consists of a glyceride composition esterified by at least one molecule of an acidulant acid per one molecule of glyceride, one carboxyl group of the esterifying acidulant acid and, one hydroxyl group of the glyceride composition having reacted to form an ester group.

Esters of fatty acid glycerides have been proposed for a variety of end uses. Thus Cornelissen J. Mattheus & al. WO 2001084945 propose citric acid glyceride esters as a component of shortening compositions. Raschke Thomas & al. EP 1023892 propose the use of such esters in cosmetic and dermatological compositions for their surfactant properties. Similar uses are described by Schneider & al. in DE 19802205. Bhirud V. S. & al. in J. Oil Technol. Assoc. India, Oct.-Dec. 1991, pp. 61/63 describe in detail the preparation and properties of the lactate and citrate of stearic acid monoglyceride as additives for bread baking.

While these and similar publications illustrate the application of known chemistry to making glycerides and to esterification of such glycerides there is nowhere the suggestion of such glyceride esters constituting oil-soluble flavors that are acidulants or acidulant precursors.

A major purpose of the present invention is to provide for glyceride ester compositions as flavors per-se as well as desirable food ingredients that fall under the designation of neutraceuticals. The perception of the distinctive taste and flavor of a specific glyceride ester composition takes place stage wise. Initially the perception is of the glyceride ester composition as such followed by the perception, of its constituents as they are liberated through the enzymatic hydrolysis that takes place of esters present in food. Impurities that may form in the preparation of a glyceride ester composition are obviously detrimental to its application as a flavor or a neutraceutical (or both). The formation of impurities can hardly be completely avoided in the thermally-driven chemical reactions used for glyceride ester composition synthesis in the prior art. Typically, impurities may be due to hydroxyl elimination with departure of H₂O and formation of a double bond; decarboxylation of a carboxyl group of the acidulant acid; cis/trans isomerisation around a double bond a fatty acid residue. Such impurities may not matter when the glyceride ester composition is used in small concentrations in shortenings (that are not ingested as such) or as auxiliaries to emulsify spices or as antioxidants at the low levels required for this function. For application as a significant ingredient of food, whether as a primary flavor or as a neutraceutical, any impurity of the described type is highly undesirable.

Thus according to the present invention there is now provided a process for the preparation of food acidulants comprising esterifying a fatty acid glyceride esterified by at least one fatty acid selected from the group consisting of fatty acids found in edible oils and fats with at least one carboxylic acid selected from the group of acidulant acids consisting of acetic acid, lactic acid, fumaric acid, malic acid, tartaric acid and citric acid to produce an oil soluble, acidulant, food component.

In preferred embodiments of the present invention said glyceride is a mono-glyceride, a di-glyceride or a mixture of mono- and di-glycerides.

As will be realized said esterification can be carried out on a glyceride of a single fatty acid or glycerides of several fatty acids.

In especially preferred embodiments of the present invention all esterifications and transesterifications between said glycerol, said fatty acid and said carboxylic acid are enzyme mediated.

In another aspect of the present invention there is now provided the use of a compound of the general Formula 1: 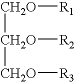
for the manufacture of an oil soluble, acidulant, food component, wherein R₁, R₂ and R₃ are the same or different and wherein each of R₁, R₂ and R₃ is selected from the group consisting of an anionic moiety of a fatty acid found in edible oils and fats, an anionic moiety of a carboxylic acid selected from the group of acidulant acids consisting of acetic acid, lactic acid, fumaric acid, malic acid, tartaric acid and citric acid, and hydrogen, provided that at least one of R₁, R₂ and R₃ is an anionic moiety of a fatty acid selected from the group consisting of fatty acids found inedible oils and fats and at least one of R₁, R₂ and R₃ is an anionic moiety of a carboxylic acid selected from the group of acidulant acids consisting of acetic acid, lactic acid, fumaric acid, malic acid, tartaric acid and citric acid.

The present invention also provides a food component comprising a glycerol esterified by at least one fatty acid selected from the group consisting of fatty acids'found in edible oils and fats and by at least one carboxylic acid selected from the group of acidulant acids consisting of acetic acid, lactic acid, fumaric acid, malic acid, tartaric acid and citric acid, wherein all esterifications and trans-esterifications between said glycerol, said fatty acid and said carboxylic acid have been enzyme mediated.

The glyceride ester compositions of the present invention are freely soluble in oils. When incorporated in foods they form the oil phase or a component of the oil phase of such foods. Acetic acid and lactic acid (the mono carboxylic acids of the six acidulant acids) form glyceride ester compositions that do not present free carboxyl COOH groups and do not therefore express directly acidic flavors that depend on free COOH groups. However acetic acid and lactic acid that are liberated by the enzymatic hydrolytic action of salivary enzymes such as salivary lipase (or enzymes that may be present in the food that contains the glyceride esters composition) are perceived as such. This perception has unique features due to the facts that the liberation is gradual and intimately associated with the oil phase from which the acid is released. Thus the glyceride ester compositions that contain the mono carboxylic acidulant acids—acetic and lactic—are, as well as novel flavors, precursors of novel acidic flavors by virtue of the dynamics of their release from these compositions.

The glyceride ester compositions that contain one of the di-carboxylic acids: fumaric, malic, tartaric present one free COOH group. The compositions that contain citric acid, which is a tri-carboxylic acid, present two free COOH groups. They are novel oil-soluble acidulants as such and of further novel uniqueness of having acidic flavors that evolve with hydrolysis by salivary enzymes and other enzymes that may be present. The two carboxylic groups provide also for flavor modulation through pH adjustment.

Glyceride compositions are readily prepared by reacting triglycerides that constitute a chosen fat or oil (or a mixture of such fats and oils) with glycerol using a chemical catalyst or an enzyme to drive the reaction to equilibrium. Catalyzed glycerolysis is extensively described in literature as a step in technologies for, obtaining mono-glycerides and di-glycerides. It consists of establishing an equilibrium:
TRIGLYCERIDES+GLYCEROL [symbol] MONOGLYCERIDES+DIGLYCERIDES

Separating a pure glyceride (mono or di) from such four component mixtures, is a rather demanding process as reflected in the price differentials between commercially available pure glycerides and the oils from which they are derived. The exercise of the present invention, however, advantageously eschews as a rule the need for such separation. It was established that the flavor of a glyceride ester composition obtained from an acidulant acid and a glyceride composition is only modestly affected by the proportion of mono to di, in the glyceride composition, in ranges beyond the preponderance of some 80% or higher of di-glyceride to mono-glyceride or vice versa. Ratios in the range of 20/80 to 80/20 can be simply established by adjusting the proportion of reagents used in the above equilibrium.

Thus, in the practice of this invention, the use of expensive pure mono or di glycerides is restricted for certain closely defined specialty products. As a rule, in the practice of making food ingredients that function primarily as flavors and flavor precursors according to this invention, one can adjust for the whole range of achievable flavors from a selected oil and a selected carboxylic acid by glyceride ester compositions corresponding to glyceride compositions in the range of di-glyceride to tri-glyceride of 20/80 to 80/20 which is achievable by simple chemical or enzymatic glycerolysis of a selected oil or the esterification of glycerol by a selected fatty acid or a mixture of fatty acids.

The present invention uses low temperature, alkali mediated trans-esterification and preferably enzyme mediated trans-esterification in the preparation of glyceride compositions when reacting oils with glycerol. The esterification of glyceride compositions to form glyceride ester compositions is restricted to enzyme mediation. The formation of impurities attendant on thermal reactions is thus totally precluded. An additional advantage of this approach is the certainty that the glyceride ester compositions will be free, of any trace of enzyme-resistant components likely to form in thermal reactions.

The stipulation of the preferred use of enzyme mediation has been possible since the advent and commercial availability of lipases that provide both for making glyceride compositions and for their esterification to make glyceride ester compositions. In the most general, way (1) oils, fatty acids and glycerol are reacted (preferentially enzymatically) to form a first equilibrium mixture of reactants and reaction products: mono- and di-glycerides (2) glycerides separated from this mixture are enzymatically esterified by an acidulant acid to form a second equilibrium mixture from which the desired glyceride ester composition is recovered. In some cases the two enzyme-mediated reactions can be done in a single sequence prior to product recovery. Whichever sequence is selected all separation processes applied to the equilibria mixtures (typically Solvent Extraction and chromatography) avoid high temperatures and are such as to preclude chemical changes in the equilibrium mixture constituents. This in turn permits the recycle of non-product constituents with the result that the primary feeds need only be in proportions such as to represent the final product. Yields, but for losses in separation procedures, approach 100%.

In the preferred approach to preparing food ingredients according to the present invention known processes of glyceride synthesis and of esterification are applied. Oil (i.e. a tri-glyceride) and glycerol are taken in relative amounts to form, after equilibration, mono-glyceride and di-glyceride in the desired proportion in an equilibrium mixture that contains unreacted tri-glyceride and glycerol. Equilibrium is established by known technologies, applying a basic catalyst or an enzyme. When the reaction progresses close to equilibrium, further catalytic action is stopped prior to proceeding with the separation of non-reacted glycerol from a homogenous liquid phase that comprises the glycerides that formed and the remaining unreacted oil. Catalytic action is stopped by removal of catalyst as a separate solid or liquid phase. A basic catalyst may be neutralized by acid prior to removal; an enzyme catalyst may be removed by filtration.

At this point oil may be added to obtain approximately one mol of tri-glyceride for every-mol of mono-glyceride or of di-glyceride. The oil being a non-solvent for glycerol its addition provides for a substantially complete separation of the glycerol into a liquid phase of higher SG than the oil phase. The glycerol that is collected efficiently by settling or centrifugation is recycled to glycerolysis. The glyceride composition can be now subjected to enzyme catalyzed esterification, free of interference by glycerol. This permits the use of the same enzymes that are applied in glycerolysis.

An auxiliary solvent that is water soluble and that has marked miscibility with glycerol and oils, such as 2-propanol (IPA) may be used to provide miscibility whereby reaction rates, are increased both in glycerolysis and in esterification. The IPA is recovered preferably by distillation with 100% removal from the product ensured by washing with water. Such a washing operation has the added benefit of removing any traces of carboxylic acids and of glycerol that may be present.

In U.S. 2002/0012739 by J. M. Cornelissen et al. there is described and claimed a shortening composition comprising a citric acid glyceride of citric acid which is claimed for pourable shortening compositions. No mention of possible acidulant function is mentioned in said application and as a suitable process for the manufacture of citric acid, esters of partial glycerides said application refers to U.S. Pat. No. 4,071,544 by Bade that makes such glycerides “by reacting citric acid with the glycerides at elevated temperatures in the presence of acetic acid”. In said latter patent the only use listed is as an emulsifier in foods and no mention of acidulant function is found in either of said publications.

In U.S. Pat. No. 2,813,032 by L. A. Hall there is described and claimed a fatty monoglyceride citrate and anti-oxidants containing the same however only thermal esterifications are described and only anti-oxidant properties are described and, claimed.

In U.S. Pat. No. 5,013,574 by Hassel there are described and claimed edible dispersions containing a tartaric acid ester of mono- and di-glycerides and an edible fat however said patent states in its Abstract that “The composition is useful in flavoring or coloring foods . . . ” and it is to be noted that this is achieved not directly by the flavor of the tartrate glyceride ester composition clamed but by virtue of dispersions by means of the this glyceride ester composition.

Thus none of said patents teach or suggest a process for the preparation of food acidulants comprising esterifying a fatty acid glyceride esterified by at least one fatty acid selected from the group consisting of fatty acids found in edible oils and fats with at least one carboxylic acid selected from the group of acidulant acids consisting of acetic acid, lactic acid, fumaric acid, malic acid, tartaric acid and citric acid to produce an oil soluble, acidulant, food component.

While the invention will now be described in connection with certain preferred embodiments in the following example so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following example which include preferred embodiments will serve to illustrate the practice of this invention, it being understood that the particulars shown are by way of example, and for purposes of illustrative discussion of preferred embodiments of the present invention only and are presented in the cause of providing what is believed to be the most useful and readily understood description of formulation procedures as well as of the principles and conceptual aspects of the invention.

### EXAMPLE

200 grs of soy oil (purchased in a food store) was mixed with 5.2 grs anhydrous glycerol and 200 grs of IPA. These proportions correspond approximately to four mols of soy oil (considered, as a triglyceride of C₁₈ fatty acids) to one mol of glycerol. This is double the theoretical amount of oil that would be needed for its conversion to diglyceride as per the reaction below:
2CH₂(OOR)CH(OOR)CH₂(OOR)+CH₂(OH)CH(OH)CH₂(OH)=3CH₂(OOR)CH(OOR)CH₂(OH)
where R stands for the hydrocarbon chains of fatty acids present in the oil (stearic, oleic, palmitic etc.). This excess of oil was chosen to drive the equilibrium towards diglyceride formation. To the above liquid mixture 10 grs of a commercial (Novo Co.) immobilized Mucor miehei lipase were added. The suspension was kept gently agitated for 48 hours at 50° C. and allowed to settle. The liquid phase was only slightly turbid. A sample of this liquid was distilled under vacuum to remove the IPA. An oily liquid of very slight turbidity remained. Adding a few drops of water, mixing and centrifuging, resulted in clear oil and a small aqueous phases. The aqueous phase was analyzed for glycerol. Only traces were found which indicated that the conversion to diglyceride was nearly complete as per the formula above and that proceeding with the removal of glycerol prior to esterification could be dispensed with 50 grs of −200 mesh anhydrous citric acid (approximately 50% in excess of the amount needed to convert all the diglycerides to their citrates) were added to the product solution of soy diglycerides containing the catalyst and the suspension thus obtained was subjected to gentle agitation for 48 hours at 50° C. The suspension, was filtered thereby removing the catalyst so as to prevent further, reaction and the clear filtrate distilled under vacuum to remove the bulk of the IPA. A suspension of solids (subsequently confirmed to be over 95% citric acid) in a clear liquid phase, that settled out rapidly, was obtained. 195 mls of the oily liquid were decanted and washed successively with three portions of 50 mls of, water at 55° C., mixing and centrifuging for separation each time. The washed product was dried under vacuum. It was a clear oil at 50° C. that partly solidified at room temperature. No IPA was detected by gas chromatography. Neutralization equivalent and acetyl values indicated a content of diglyceride citrate (taking into account the excess of oil used in the glycerolysis) of over 97%.

The above example illustrates the simplicity with which known art can be used to prepare the food components of the present invention.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intento be embraced therein.

1-11. (canceled)

12. A process for the preparation of an acid flavored food component comprising esterifying a fatty acid glyceride esterified by at least one fatty acid selected from the group consisting of fatty acids found in edible oils and fats with at least one carboxylic acid selected from the group of acidulant acids consisting of acetic acid, lactic acid, fumaric acid, malic acid, tartaric acid and citric acid to produce an oil soluble, acidulant, food component for providing an acid flavor to a food.

13. The process of claim 1 wherein said glyceride is a mono-glyceride.

14. The process of claim 1 wherein said glyceride is a di-glyceride.

15. The process of claim 1 wherein said glyceride is a mixture of mono- and di-glycerides.

16. The process of claim 1 wherein said glyceride is a glyceride of a single fatty acid.

17. The process of claim 1 wherein said glyceride is a glyceride of several fatty acids.

18. The process of claim 1 wherein all esterifications and transesterifications between said glycerol, said fatty acid and said carboxylic acid are enzyme mediated.

19. The use of a compound of the general Formula 1:
CH₂O—R₁ |CHO—R₂ |CH₂O—R₃
for the manufacture of an oil soluble, acidulant, food component, for providing an acid flavor to a food, wherein R₁, R₂ and R₃ are the same or different and wherein each of R₁, R₂ and R₃ is selected from the group consisting of an anionic moiety of a fatty acid found in edible oils and fats, an anionic moiety of a carboxylic acid selected from the group of acidulant acids consisting of acetic acid, lactic acid, fumaric acid, malic acid, tartaric acid and citric acid, and hydrogen, provided that at least one of R₁, R₂ and R₃ is an anionic moiety of a fatty acid selected from the group consisting of fatty acids found in edible oils and fats and at least one of R₁, R₂ and R₃ is an anionic moiety of a carboxylic acid selected from the group of acidulant acids consisting of acetic acid, lactic acid, fumaric acid, malic acid, tartaric acid and citric acid.

20. A glyceride ester composition containing at lest one compound of the general Formula 1 as defined in claim 8 whenever used in the manufacture of an oil soluble, acidulant, food component for providing an acid flavor to a food.

21. A food component for providing an acid flavor to a food, comprising a glycerol esterified by at least one fatty acid selected from the group consisting of fatty acids found in edible oil and by at least one carboxylic acid selected from the group of acidulant acids consisting of acetic acid, lactic acid, fumaric acid, malic acid, tartaric acid and citric acid, wherein all esterifications and transesterifications between said glycerol, said fatty acid and said carboxylic acid have been enzyme mediated.

22. The use of a glycerol esterified by at least one fatty acid selected from the group consisting of fatty acids found in edible oils and fats and at least one carboxylic acid selected from the group of acidulant acids consisting of acetic acid, lactic acid, fumaric acid, malic acid, tartaric acid and citric acid for the manufacture of an oil soluble, acidulant, food component, for providing an acid flavor to a food, wherein all esterifications and transesterifications between said glycerol, said fatty acid and said carboxylic acid are enzyme mediated.

23. A method for enhancing an acidic taste of a food product, said method comprising adding to said food product an amount of a glycerol esterified by at least one fatty acid selected from the group consisting of fatty acids found in edible oil and by at least one carboxylic acid selected from the group of acidulant acids consisting of acetic acid, lactic acid, fumaric acid, malic acid, tartaric acid and citric acid, the amount of said esterified fatty acid glycerol being sufficient to enhance the acidic taste of said food product.
